(19) United States
(12) Patent Application Publication
(10) Pub. No.: US 2015/0002506 A1
(43) Pub. Date: Jan. 1, 2015

(54) METHOD AND APPARATUS FOR PROVIDING AUGMENTED REALITY DISPLAY SPACES

(71) Applicant: HERE Global B.V., Veldhoven (NL)

(72) Inventors: Anssi Kustaa SAARIMÄKI, Veldhoven (NL); Daniel Cornelius Manuel SEYDE, Berlin (DE)

(21) Appl. No.: 13/930,644

(22) Filed: Jun. 28, 2013

(51) Int. Cl. G06T 19/00

(52) U.S. Cl. CPC G06T 19/006
USPC 345/419; 345/633

(57) ABSTRACT

An approach is provided for providing augmented reality display spaces. The content platform may determine one or more display surfaces within proximity of at least one device, wherein the one or more display surfaces are associated with one or more structures within an environment. Then, the content platform may cause, at least in part, a retrieval of (a) one or more detection patterns for identifying the one or more display surfaces, the one more structures, or a combination thereof in an augmented reality view; (b) content information associated with the one or more display surfaces; or (c) a combination thereof. The pattern platform may determine one or more three-dimensional (3D) models of one or more structures within an environment. Then, the pattern platform may process and/or facilitate a processing of the one or more 3D models to determine one or more potential display surfaces on the one or more 3D models. Lastly, the pattern platform may cause, at least in part, a verification of the one or more potential display surfaces against one or more reference 3D models to determine one or more available display surfaces.

### BACKGROUND

Service providers and device manufacturers (e.g., wireless, cellular, etc.) are continually challenged to deliver value and convenience to consumers by, for example, providing compelling network services. One area of interest has been the development of distributing content in augmented reality. For example, consumers may expect to see content displayed in various spaces, for example, bus stops, billboards, on the sides of buildings, etc. Displays in augmented reality often overlap or block structures that appear in person. As a result, content providers face significant challenges distributing content as content may appear in life.

### SOME EXAMPLE EMBODIMENTS

Therefore, there is a need for an approach for providing augmented reality display spaces.

According to one embodiment, a method comprises determining one or more display surfaces within proximity of at least one device, wherein the one or more display surfaces are associated with one or more structures within an environment. The method also comprises causing, a least in part, a retrieval of (a) one or more detection patterns for identifying the one or more display surfaces, the one or more structures, or a combination thereof in an augmented reality view; (b) content information associated with the one or more display surfaces; or (c) a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more display surfaces within proximity of at least one device, wherein the one or more display surfaces are associated with one or more structures within an environment. The apparatus is also caused to cause, a least in part, a retrieval of (a) one or more detection patterns for identifying the one or more display surfaces, the one or more structures, or a combination thereof in an augmented reality view; (b) content information associated with the one or more display surfaces; or (c) a combination thereof.

According to another embodiment, a computer-readable storage medium carries one or more sequences of one or more instructions which, when executed by one or more processors, cause, at least in part, an apparatus to determine one or more display surfaces within proximity of at least one device, wherein the one or more display surfaces are associated with one or more structures within an environment. The apparatus is also caused to cause, a least in part, a retrieval of (a) one or more detection patterns for identifying the one or more display surfaces, the one or more structures, or a combination thereof in an augmented reality view; (b) content information associated with the one or more display surfaces; or (c) a combination thereof.

According to another embodiment, an apparatus comprises means for determining one or more display surfaces within proximity of at least one device, wherein the one or more display surfaces are associated with one or more structures within an environment. The apparatus also comprises means for causing, a least in part, a retrieval of (a) one or more detection patterns for identifying the one or more display surfaces, the one or more structures, or a combination thereof in an augmented reality view; (b) content information associated with the one or more display surfaces; or (c) a combination thereof.

According to one embodiment, a method comprises determining one or more three-dimensional (3D) models of one or more structures within an environment. The method also comprises processing and/or facilitating a processing of the one or more 3D models to determine one or more potential display surfaces on the one or more 3D models. The method further comprises causing, at least in part, a verification of the one or more potential display surfaces against one or more reference 3D models to determine one or more available display surfaces.

According to another embodiment, an apparatus comprises at least one processor, and at least one memory including computer program code for one or more computer programs, the at least one memory and the computer program code configured to, with the at least one processor, cause, at least in part, the apparatus to determine one or more three-dimensional (3D) models of one or more structures within an environment. The apparatus is also caused to process and/or facilitate a processing of the one or more 3D models to determine one or more potential display surfaces on the one or more 3D models. The apparatus is further caused to cause, at least in part, a verification of the one or more potential display surfaces against one or more reference 3D models to determine one or more available display surfaces.

According to another embodiment, a computer-readable storage medium carries one or more sequences of one or more instructions which, when executed by one or more processors, cause, at least in part, an apparatus to determine one or more three-dimensional (3D) models of one or more structures within an environment. The apparatus is also caused to process and/or facilitate a processing of the one or more 3D models to determine one or more potential display surfaces on the one or more 3D models. The apparatus is further caused to cause, at least in part, a verification of the one or more potential display surfaces against one or more reference 3D models to determine one or more available display surfaces.

According to another embodiment, an apparatus comprises means for determining one or more three-dimensional (3D) models of one or more structures within an environment. The apparatus also comprises means for processing and/or facilitating a processing of the one or more 3D models to determine one or more potential display surfaces on the one or more 3D models. The apparatus further comprises means for causing, at least in part, a verification of the one or more potential display surfaces against one or more reference 3D models to determine one or more available display surfaces.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-11, 23-33, and 49-52.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing augmented reality display spaces, according to one embodiment;

FIG. 2A is a diagram of the components of a pattern platform that provides display structures and detection patterns, according to one embodiment;

FIG. 2B is a diagram of the components of a content platform that renders content using high accuracy wireframes or 3D models, according to one embodiment;

FIG. 3 is a diagram of the components of a detection pattern module that determines transmission of detection patterns to devices, according to one embodiment;

FIG. 4 is a flowchart of a process for providing augmented reality display spaces, according to one embodiment;

FIG. 5 is a flowchart of a process for rendering content information on at least a portion of the display spaces, according to one embodiment;

FIG. 6 is a flowchart of a process for determining available display spaces, according to one embodiment;

FIG. 7 is a flowchart of a process for transmitting appropriate detection patterns to a device, according to one embodiment;

FIG. 8 is a diagram of a system for processing 3D models and verifying potential display surfaces to determine available display surfaces, according to one embodiment;

FIG. 9 is a diagram of a rendering 900 of an augmented reality view utilized in the processes of FIG. 5, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for providing augmented reality display spaces are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

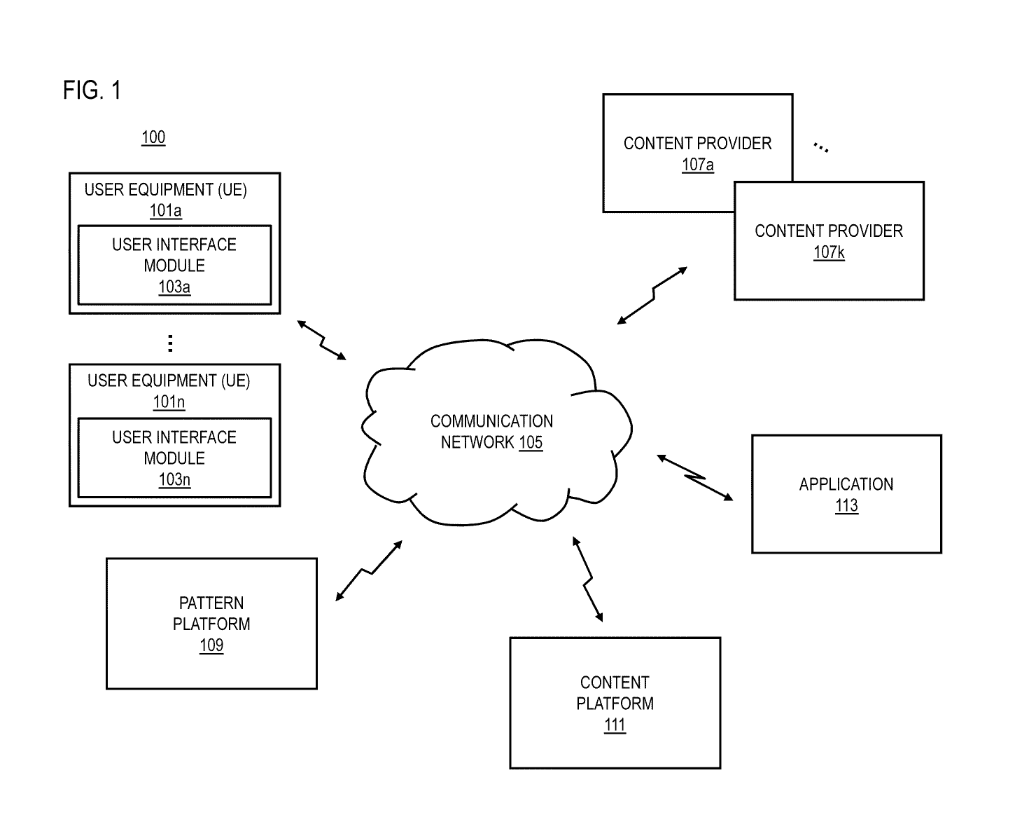

FIG. 1 is a diagram of a system capable of providing augmented reality display spaces, according to one embodiment. Service providers and device manufacturers (e.g., wireless, cellular, etc.) are continually challenged to deliver value and convenience to consumers by, for example, providing compelling network services. One area of interest has been the development of distributing content in augmented reality. For example, consumers may expect to see content displayed in various spaces. For example, consumers may expect advertisements to be displayed at bus stops, billboards, on the sides of buildings, on the sides of buses, inside public transportation stations and vehicles, etc. Displays in augmented reality often overlap or block structures that appear in person. For example, displays in augmented reality often are not displayed in the same areas that consumers expect to see content in real life. As a result, content providers face significant challenges in distributing content as consumers may expect content to be displayed.

To address this problem, a system 100 of FIG. 1 introduces the capability to provide augmented reality display spaces, according to one embodiment. In one embodiment, the system 100 may determine a user approaching a display surface. A display surface may include any space where content might be displayed. For example, a display surface may include a space on the side of a bus stop where advertisements or bus schedules might commonly be displayed. The display surface may be associated with structures in an environment. For instance, the bus stop may be a structure where the side of the bus stop is a display surface. In another environment, another side of a bus stop may be a display surface due to a different bus stop structure. For example, bus stop structures in New York City might have display surfaces on lateral sides whereas bus stop structures in Washington, D.C. may have display surfaces only on backsides of the bus stop.

Then, the system 100 may cause retrieval of detection patterns for identifying the display surfaces, the structures, or a combination thereof in augmented reality view. The system 100 may also cause retrieval of content information associated with the display surfaces or a combination of detection patterns, structures, and/or content information. For example, the system 100 may identify the display surfaces, structures, or a combination thereof in the augmented reality view based on detection patterns. Detection patterns may include patterns that trigger identification of the display surfaces or structures. For instance, a bus stop detection pattern may include a set of quadrilaterals in a certain grouping. Detection patterns may be associated with environments, just as display surfaces and structures may be environment-based. Then, the system 100 may cause, at least in part, a fixing of one or more three-dimensional (3D) models that represent the display surfaces, structures, or a combination thereof to the surfaces and structures in an augmented reality view to render content information on at least a portion of the 3D models. The 3D models may include high accuracy wireframes that reflect the structures in augmented reality view. For example, fixing 3D models to display surfaces and structures in an augmented reality view may cause the models to be at the locations of the display surfaces and structures in augmented reality view, regardless of how a user is accessing the augmented reality view.

In one embodiment, the system 100 may process sensor data associated with a device to stabilize the fixing of the 3D models in relation to the display surfaces and structures identified in the augmented reality view. For example, the 3D model and/or display surface may follow the perspective of the augmented reality view based on the orientation of the user device and distance between the user device and location of the 3D model and/or display surface. For instance, if a user moves his device up and then down, a bus stop within the augmented reality view of the device may move from the bottom of the screen when the device is “up”, to the top of the screen when the device is “down.” In turn, the rendering of content information also stays on the 3D model relative to user movement. In this case, the system 100 may cause rendered content to remain within a display surface associated with the bus stop, regardless of device movement. In other words, the content item would not stay in the same place on a user's user interface regardless of the user's movement. Rather, content would shift in the screen with the bus stop so that the augmented reality view is stable throughout a device's movement. The system 100 (or device within system 100) has fixed the 3D model and/or display surface (based on a wireframe) to a respective real world object on an augmented reality view.

In one embodiment, the system 100 may process the sensor data to determine movement of the device and cause some changing in the rendering based on the level of movement. For example, if sensor data indicates inaccuracy or there is too much movement to show content in a stable manner, system 100 may dim or hide the content. In a further embodiment, the system 100 may continually verify and update 3D models and detection patterns based on user feedback. For example, users may provide the system 100 data about the rendered content for validation. For example, users may send a snapshot of an image to the system 100, whereupon the system 100 may process the image and return a detection pattern for the next time the location and/or structure of the snapshot is part of the augmented reality view. Such user participation may permit users to add to the display surfaces recognized by system 100 and strengthen feedback channels employed by system 100. Furthermore, the system 100 may permit or prompt users to mark structures they perceive as good display surfaces for future content display. For example, a user may face an empty wall of a building while waiting for a bus during his daily commute. The system 100 may permit the user to mark the wall as a display surface, where the system 100 may then construct a detection pattern for the wall and permit content display in the augmented reality view of the wall in the future. For instance, the system 100 may allow the user to elect to read his email on the augmented reality view of the empty wall. Alternately or in addition, the system 100 may track user behavior relative to the rendered content for validation, without directly engaging the users. Where validation is lacking, the system 100 may remove or replace 3D models and detection patterns associated with structures in an environment or seek to gather new information regarding the structures.

In another embodiment, the system 100 may first determine 3D models of structures within an environment and determine potential display surfaces on the 3D models. In other words, the system 100 may pre-process 3D models of structures and prepare display surfaces of the structures for content display. In doing so, the system 100 may reduce processing needs of user devices within system 100, enabling the user devices to process display surfaces and display content in near real time. In one embodiment, the system 100 may do so by acquiring 3D models of environments from various vehicles and processing the 3D models of environments to determine repeating 3D models within the 3D models of environments.

The system 100 may also draw from sources including 3D city models, traditional maps, indoor maps, and/or satellite imagery to acquire 3D models. For example, the system 100 may directly receive 3D city models or determine 3D models from traditional maps. Furthermore, the system 100 may detect available sources based on location or environment information and identify 3D models by aggregating or processing information provided by the detected sources. In one embodiment, the system 100 may identify the structures by identifying patterns based on shape, color, size, proximity to specific places, levitation, movement, etc. For example, where structures involve moving objects, the system 100 may identify the structures not only by geometric shapes characteristic of the structures, but by movement characteristic of the structure. For instance, buses move according to particular schedules and trolleys may move only along certain tracks. The system 100 may use such information about movement to define structures and associated display surfaces (and detection patterns) associated with the structures.

The system 100 may then determine one or more potential display surfaces on the 3D models, for example, by determining bound, 2-dimensional (2D) surfaces. Following this step, the system 100 may compare the repeating 3D models against one or more reference 3D models to verify the potential display surfaces, thereby determining available display surfaces. In another embodiment or in a further embodiment, the system 100 may take location detection into account to identify the structures, 3D models, and/or display surfaces. For example, the 3D models of structures and/or display surfaces may include related metadata including physical location information of detected structures and/or display surfaces. Such metadata may include, for instance, coordinates and elevation of the structures and display surfaces, number of display surfaces, sizes of display surfaces within the 3D models, and respective viewing angles of various display surfaces.

The system 100 may also create the detection patterns for identifying available display surfaces, structures, or a combination thereof in an augmented reality view based on the determined available display surfaces. For example, detection patterns may be a simplified version of the 3D models or an approximation of the display surfaces. The detection patterns may be a minimal structural identifier needed to signal the presence of an available display surface in an environment. For example, the detection pattern may draw from shape, color, or size characteristics that initially facilitated identification of a structure and/or display surface. The system 100 may infer that characteristics that initially permitted identification are also distinguishing characteristics sufficient to serve as detection patterns for identification in displaying content. Furthermore, the system 100 may apply metadata from the 3D models in creating the detection patterns. For instance, the system 100 may construct detection patterns to account for various viewing angles and display surfaces to that the system 100 may identify structures and/or display surfaces associated with the detection patterns from various angles of approach to the structures.

In one embodiment, the system 100 may group detection patterns by geographic area and/or viewing angle. For example, the system 100 may associate a local geographic area with one or more detection patterns considered “standard” for the geographic area. For instance, if a device within system 100 enters the geographic area, the device may receive or request to receive detection patterns associated with the local area. The system 100 may define the geographic areas and/or pre-configure radiuses surrounding devices where the system 100 may initiate detection pattern transmission and content display. In one scenario, servers within the system 100 may determine the detection patterns, determine associations between detection patterns or between detection patterns and geographic locations, determine groupings of detection patterns based on geographic areas and subsequently transfer to the detection patterns to requesting devices. Alternately, the system 100 may transmit detection patterns to devices as part of normal map content delivery, without taking factoring in device location or viewing angle information.

In one embodiment, the system 100 may package the available display surfaces, content information for display, detection patterns, or a combination thereof for transmission to a device proximate to the structures. For example, display surfaces may be packaged by location, as described above. In another example, display surfaces may be packaged by type. For instance, bus stop advertisements may comprise one package and subway train billboards, another package. Content information type may likewise be packaged, for example, by type, location (and region), association with display spaces, etc. Detection patterns may be packaged in the same ways and/or bundled together with display surfaces or content information. In one embodiment, detection patterns are packaged separately from display surfaces or content information to speed and ease transmission, where display surface or content information is requested only after detection patterns are found to match structures in an augmented reality view. In one embodiment, the system 100 may detect a device proximate one or more structures and initiate transmission of detection patterns to the device.

As shown in FIG. 1, the system 100 comprises a user equipment (UE) 101a-101n (or UEs 101) having connectivity to user interface modules 103a-103n (or user interface modules 103), content providers 107a-107k (or content providers 107), a pattern platform 109, a content platform 111, and an application 113 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the user interface modules 103 may present the content renderings in augmented reality views and provide back end data for continuous improvement and validation of the 3D models, detection patterns, and/or content. In one embodiment, the user interface modules 103 may request manual confirmation or user input for verifying display surfaces. For example, the user interface modules 103 may render a content item and request input regarding whether the content item is, in fact, in a display surface as the user may expect to see it in life. Furthermore, the user interface modules 103 may interact with the application 113 to initiate augmented reality views and content display.

In one embodiment, the content providers 107 may provide the 3D models of the environment. For example, content providers 107 may include map databases based on vehicle-collected data. Content providers 107 may further provide details and 3D models on interiors, for example, the interiors of buildings or vehicles. Content providers 107 may also include vendors, for example, trolley services with schedules. By this embodiment, system 100 may further include display surfaces associated with moving structures.

In one embodiment, the pattern platform 109 may determine the 3D models of structures within an environment, determine display surfaces associated with the 3D models, and create detection patterns based on the models. In one embodiment, the pattern platform 109 may determine the 3D models by identifying structures or potential structures within augmented reality models from content providers 107. For example, the pattern platform 109 may determine the structures by automatically or manually confirming detection of structures, determining repeating shapes within the 3D models, or employing various means of image recognition of known structures. Then, the pattern platform 109 may determine display surfaces associated with the 3D modes. In one embodiment, the pattern platform 109 may determine the display surfaces by comparing determined 3D models structures against reference models from a database. To create detection patterns based on the models, the pattern platform 109 may design an abstracted version of the 3D models of the structures, determined display surfaces associated with the structures, or a combination thereof.

In one embodiment, the content platform 111 may interact with UEs 101 to receive detection patterns where the content platform 111 determines proximity between a given UE 101a with an identifiable structure. For example, upon determination of proximity, the content platform 111 may cause the pattern platform 109 to transmit the detection patterns to the UE 101a, whereupon the content platform 111 may render content onto available display surfaces. For example, the content platform 111 may fix a 3D model of a structure to a rendering of the structure in an augmented reality view and render content information within a display surface associated with the 3D model so that the content is stabilized within the display surfaces of the 3D model. For example, the content platform 111 may produce renderings where content stays in the display surface of the 3D model despite device movement.

In one embodiment, the application 113 may serve as the means by which the UEs 101 interact with the pattern platform 109 and content platform 111. For example, the application 113 may activate upon detection that a UE 101s has entered a location where pattern platform 109 and content platform 111 has established detection patterns and associated content. Then, the application 113 may cause the UE 101 to request detection patterns from pattern platform 109 and subsequently engage content platform 111 to help render content on display surfaces of structures in augmented reality views.

By way of example, the UEs 101, user interface modules 103, content providers 107, pattern platform 109, content platform 111, and application 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

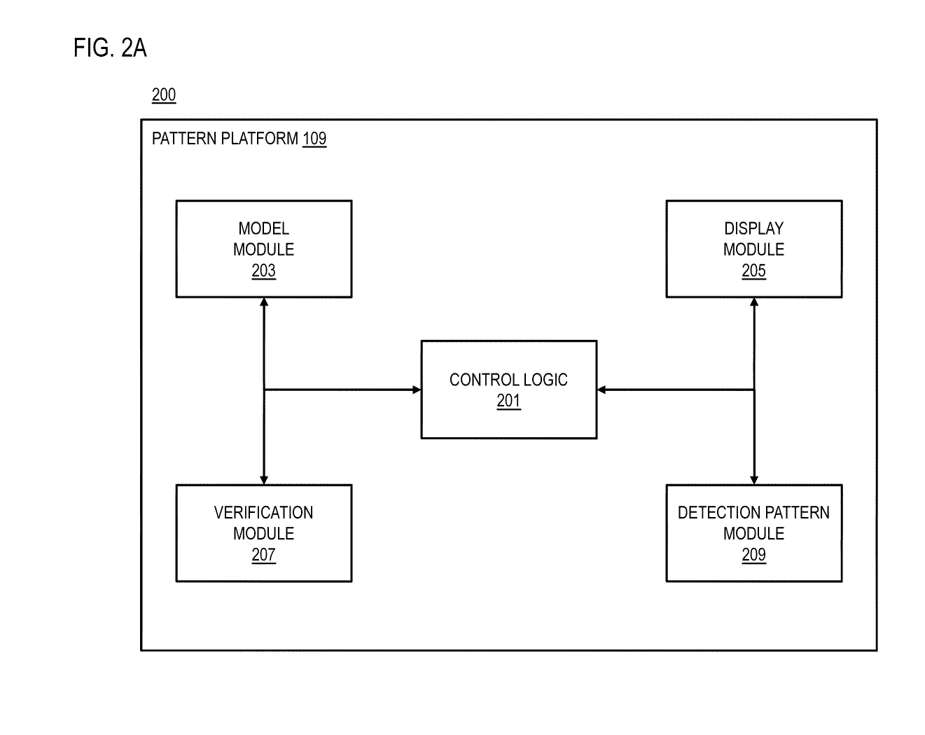

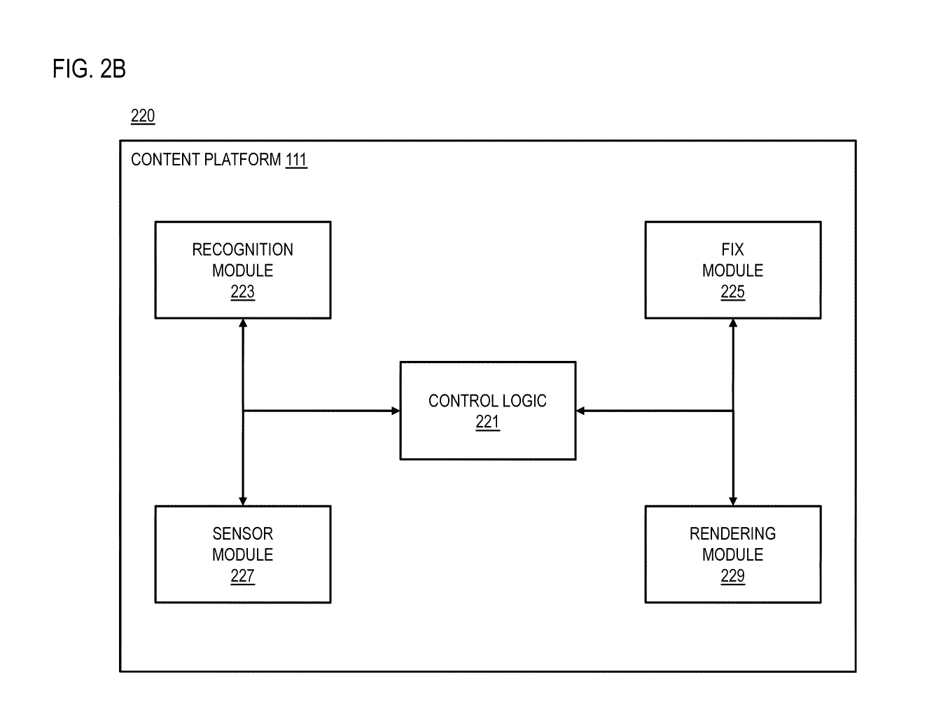

FIG. 2A is a diagram of the components of the pattern platform 109, according to one embodiment. By way of example, the pattern platform 109 includes one or more components for providing display structures and detection patterns. It is contemplated that the functions of these components may be combined in one or more components or performed by other components of equivalent functionality. In this embodiment, the pattern platform 109 includes a control logic 201, model module 203, a display module 205, a verification module 207, and a detection pattern module 209.

In one embodiment, control logic 201 and model module 203 may determine one or more 3D models within an environment. For example, the control logic 201 and model module 203 may interact with the content providers 107 to obtain 3D models of environments. Then, the control logic 201 and model module 203 may rely on heuristics to recognize structures within an environment. For example, the control logic 201 and model module 203 may determine repeating structures within the 3D models of environments and identify them as structures. Then, the control logic 201 and model module 203 may determine 3D models of the structures.

In one embodiment, the control logic 201 and display module 205 may then process the 3D models to determine display surfaces on the 3D models. For example, the control logic 201 and display module 205 may recognize advertising spaces via a pattern match algorithm. For instance, the control logic 201 and display module 205 may determine standard advertising sizes or dimensions to identify display surfaces. In one scenario, the control logic 201 and display module 205 may determine that advertisements or content are displayed in 3×2 feet rectangular spaces. The control logic 201 and display module 205 may then pinpoint display surfaces upon recognizing 3×2 rectangles in structures. In another instance, the control logic and display module 205 may employ image recognition, including text, area/size, and/or frame. For example, text may include key terms by service providers. Area/size and frame are similar to the example described with respect to the 3×2 rectangular spaces, except that the control logic 201 and display module 205 may determine the spaces by image recognition rather than by processing the 3D models.

In one embodiment, the control logic 201 and verification module 207 may verify the potential display surfaces against reference 3D models to determine available display surfaces. In one embodiment, content providers 107 may provide the control logic 201 and verification module 207 with reference 3D models. For example, the control logic 201 and verification module 207 may interact with the content providers 107 conveying information regarding an environment. For instance, the control logic 201 and verification module 207 may request models associated with the tag, “New York City.” Then, the content providers 107 may transmit to the control logic 201 and verification module 207, reference 3D models associated with New York City. In one embodiment, the control logic 201 and verification module 207 may further verify potential display surfaces against structures submitted by UEs 101. For example, the control logic 201 may interact with user interface modules 103 to receive display surfaces seen or preferred by users. In one embodiment, the control logic 201 and verification module 207 may then separate out potential display spaces from actual, available display spaces based on the comparison between potential display surfaces and reference modules from the content providers 107.

In one embodiment, the control logic 201 and detection pattern module 209 may construct detection patterns. For example, the control logic 201 and detection pattern module 209 may determine a simplified version or approximation of the display surfaces, structures, or a combination thereof to serve as a detection pattern for the surfaces, structures, or a combination thereof. The control logic 201 and detection pattern module 209 may further ensure that created detection patterns are simple but distinct enough to distinguish between one type of structure or surface and another.

FIG. 2B is a diagram of the components of the content platform 111, according to one embodiment. By way of example, the content platform 111 includes one or more components for rendering content using high accuracy wireframes or 3D models. It is contemplated that the functions of these components may be combined in one or more components or performed by other components of equivalent functionality. In this embodiment, the content platform 111 includes a control logic 221, a recognition module 223, a fix module 225, a sensor module 227, and a rendering module 229.

In one embodiment, the control logic 221 and recognition module 223 may determine display surfaces proximate a device. Then, the control logic 221 and recognition module 223 may cause retrieval of detection patterns for identifying the display surfaces, structures in the environment associated with the display surfaces, or a combination thereof in an augmented reality view. For example, the control logic 221 and recognition module 223 may interact with the pattern platform 109 to retrieve detection patterns so that the control logic 221 and recognition module 223 may identify the display surfaces and structures in the augmented reality view. In one embodiment, the control logic 221 and recognition module 223 may run a pattern match algorithm to identify the display surfaces and structures.

In one embodiment, the control logic 221 and fix module 225 may fix 3D models that represent the display surfaces or structures to the display surfaces and structures identified in the augmented reality view. For example, the control logic 221 and fix module 225 may determine various possible view angles from which a user may approach the display surfaces or structures. In another instance, the control logic 221 and fix module 225 may also determine user distances from the display surfaces or structures from which the control logic 221 and recognition module 223 may identify various display surfaces and structures.

In one scenario, the control logic 221 and fix module 225 may determine the user distances in the form of determining minimum or maximum viewing sizes approximating how close a user would be to the display surfaces and structures for user-friendly content delivery. For example, after the control logic 221 and recognition module 223 has identified a bus stop in an augmented reality view, the control logic 221 and fix module 225 may determine that the bus stop is usually approached from the front and sides since the back of the bus stop is an open field. The control logic 221 and fix module 225 may then determine that the bus stop is on level ground, so view angles are with very little tilt and users typically stand a few feet from the bus stop display surfaces. Then, the control logic 221 and fix module 225 may determine the views of a 3D model of the bus stop taking into account this information to appropriately fix the bus stop 3D model to the bus stop identified in the augmented reality view. In other words, the control logic 221 and fix module 225 may ensure that the 3D model follows the augmented reality view of a real world structure based on the orientation and distance of a device or user with respect to the structure or location of the structure.

The control logic 221 and sensor module 227 may then help to tailor a rendering to a particular UE 101's approach to a structure or display structure in an augmented reality view. For example, the control logic 221 and sensor module 227 may process sensor data associated with, for instance, UE 101a to stabilize the fixing of the 3D models in relation to the display surfaces or structures in the augmented reality view. In one embodiment, the control logic 221 and sensor module 227 may interact with the UE 101a to determine the position and orientation of the UE 101a. Then, the control logic 221 and sensor module 227 may compare the location and direction of the UE 101a relative to the views determined by the control logic 221 and fix module 225 so that the 3D models seen by UE 101a are fixed to the display surfaces and structures as seen in the augmented reality view seen by UE 101a. In other words, even as the UE 101a moves, the control logic 221, fix module 225, and sensor module 227 interact to ensure that the 3D models are fixed on the display surfaces and structures in the augmented reality view, even as the display surfaces and structures in the augmented reality view shifts with the user's movement. In doing so, rendering of content information on the 3D models or portions of the 3D models may match how a user may experience content item display in display spaces in real life. As previously discussed, the 3D models and/or detection patterns may be comprised of wireframe models.

In one embodiment, the control logic 221 and rendering module 229 may retrieve content information associated with the display surfaces and cover the display surface with the content information. For example, the control logic 221 and rendering module 229 may request one or more content items from various vendors or content providers when the control logic 221 and recognition module 223 detect a display surface. In one embodiment, the control logic 221 and rendering module 229 may determine one or more content items specifically associated with a given display surface. For example, the control logic 221 and rendering module 229 may determine that certain types of content are presented on display surfaces meeting a given set of criteria. One exemplary scenario may include a situation where all bus stops in a city are to display bus schedules on a display surface on the left side of the bus stops. The control logic 221 and recognition module 223 may determine the configurations of a display surface and identify the surface as being a display surface on the left side of a bus stop and cause the rendering module 229 to initiate presentation of a bus schedule. In another instance, the control logic 221 and rendering module 229 may determine content to present based on location. In one such case, right sides of bus stops may include bus route maps. Then, the control logic 221 and rendering module 229 may determine user device location information in addition to identifying a bus stop right side display surface to initiate presentation of the relevant route map for the buses associated with the buses that frequent that particular location.

In another embodiment, the control logic 221 and rendering module 229 may interact with the fix module 225 and sensor module 227 where device sensor data may influence the rendering. For example, where the control logic 221 and sensor module 227 detect that movement is so great, the control logic 221 and fix module 225 may not stabilize a 3D model against structures or display surfaces in an augmented reality view, the control logic 221 and rendering module 229 may dim, hide, or somehow alter rendering of content information based on the level of movement. In one embodiment, the control logic 221 and rendering module 229 may also interact with the fix module 225 and sensor module 227 in that various angles of approach or tilt angles may cause the control logic 221 and rendering module 229 to render different content items. For example, the control logic 221 and rendering module 229 may be configured to provide more information on a particular content item in response to changing the orientation of the user device. For instance, a user may tilt his device to cause the control logic 221 and rendering module 229 to present further details on some content. One such case may include a user initially seeing a bus schedule displayed in on a display surface. He may then tilt his device to a 45 degree angle to see road condition information to see if there may be any delays in bus arrival time.

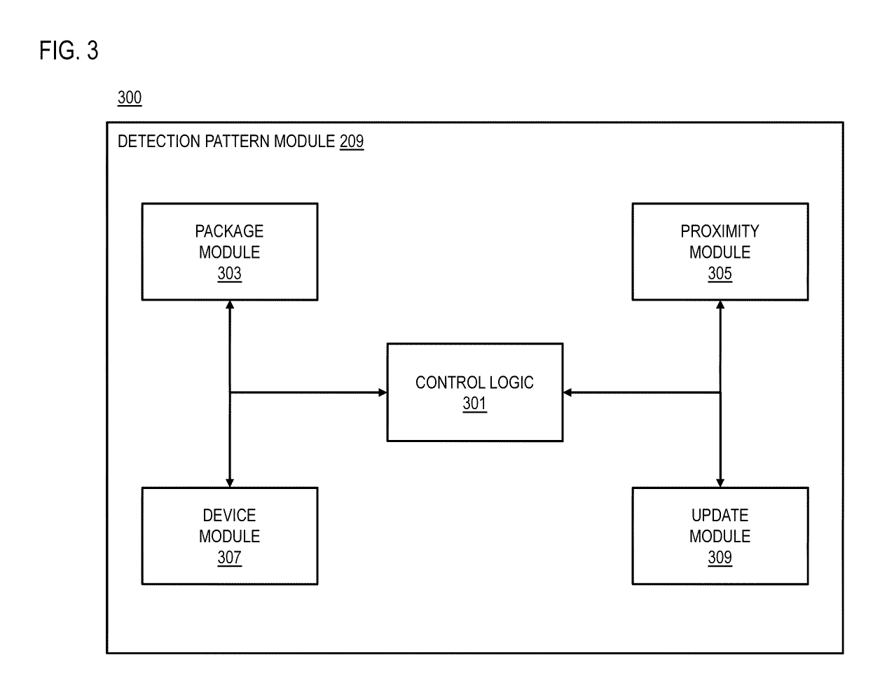

FIG. 3 is a diagram of the components of the detection pattern module 209, according to one embodiment. By way of example, the detection pattern module 209 includes one or more components for transmitting detection patterns. It is contemplated that the functions of these components may be combined in one or more components or performed by other components of equivalent functionality. In this embodiment, the detection pattern module 209 includes a control logic 301, a package module 303, a proximity module 305, a device module 307, and an update module 309.

In one embodiment, the control logic 301 and package module 303 may cause a packaging of available display surfaces, content information, detection patterns, or a combination thereof for transmission. In one embodiment, the control logic 301 and package module 303 may determine similarities between various display surfaces, content information, or detection patterns to determine appropriate groupings of the surfaces, information, and detection patterns. The control logic 301 and package module 303 may also take into account UE 101 capabilities and capacity in determining packaging groupings. In one embodiment, the control logic 301 and package module 303 may work in conjunction with advertisement or content providers in determining how content should be distributed and displayed or associations between display surfaces and content information. In another embodiment, advertisement providers may interact with the control logic 301 and package module 303 to purchase or design advertisement or content packages to drive content distribution. In a further embodiment, the control logic 301 and package module 303 may update packaging of display surfaces, content information and detection patterns based on information on user or consumer trends.

In yet another embodiment, the control logic 301 and package module 303 may take into account geographic areas in grouping display surfaces, content information, and detection patterns into packages. For example, the control logic 301 and package module 303 may identify overlapping geographic areas or define geographic areas and construct groups of display surfaces, content information, or detection patterns based on the areas. For instance, billboards on highways may be a certain configuration with a detection pattern of a simple rectangle of particular dimensions. Then, the control logic 301 and package module 303 may associate the rectangle detection pattern with geographic areas between urban centers so that UEs 101 receive the rectangle detection pattern while traveling away from an urban center along a highway. Billboards within a city, however, might be smaller and closely displayed, so a detection pattern may include a grid for bulletin board-like display surfaces. In one scenario, the control logic 301 and package module 303 may package the grid detection pattern with other detection patterns associated with the perimeter of the city so that UEs 101 receive the grid detection pattern and detection patterns packaged with the grid detection pattern upon entering the city.

In one embodiment, the control logic 301 and proximity module 305 may cause the control logic 201 to transfer detection patterns to UEs 101 when devices are proximate device surfaces or structures. For example, the control logic 301 and proximity module 305 may interact with application 113 where application 113 may activate UEs 101 to receive or request detection patterns where the control logic 201 determines that UEs 101 are entering an area where control logic 201 has knowledge of available display surfaces. In one embodiment, the control logic 301 and proximity module 305 may monitor the locations of UEs 101 associated with application 113. When UEs 101 are within a predetermined radius of available display surfaces determined by control logic 201, control logic 301 and proximity module 305 may prompt transmission of detection patterns to the UEs 101, for instance, via application 113.

In one embodiment, the control logic 301 and device module 307 may determine feedback information from the devices to which the control logic 301 has transferred detection patterns. For example, the control logic 301 and device module 307 may continue to track device location, user activity, user interaction with content rendered on the display surfaces, subsequent user purchase information, or a combination thereof to determine feedback information on the accuracy of detection patterns for identifying the available display surfaces or structures.

In one embodiment, the control logic 301 and update module 309 may then update the detection patterns based, at least in part, on the feedback information. For instance, if bus schedule information is persistently being displayed on the side of a building in addition to bus stops because the detection pattern is ambiguously the side of the building and bus stops, the control logic 301 and update module 309 may update the detection pattern to distinguish bus stops from the buildings so content is not rendered erroneously.

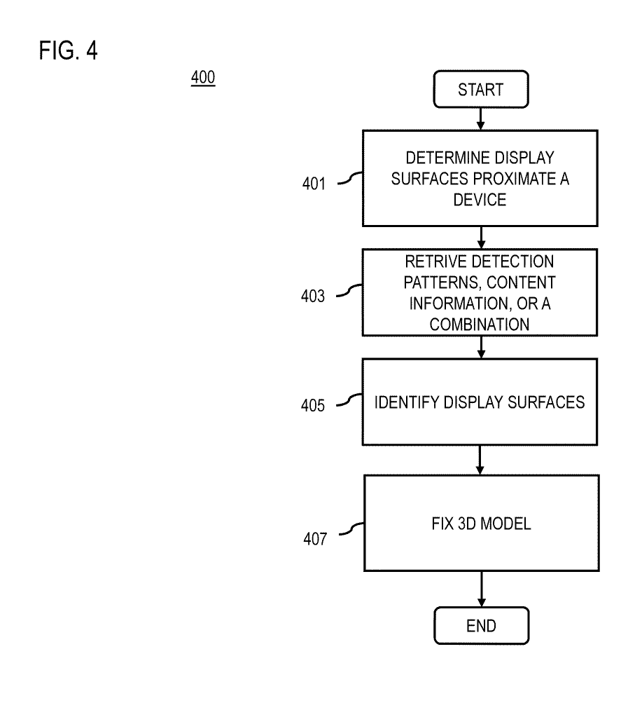

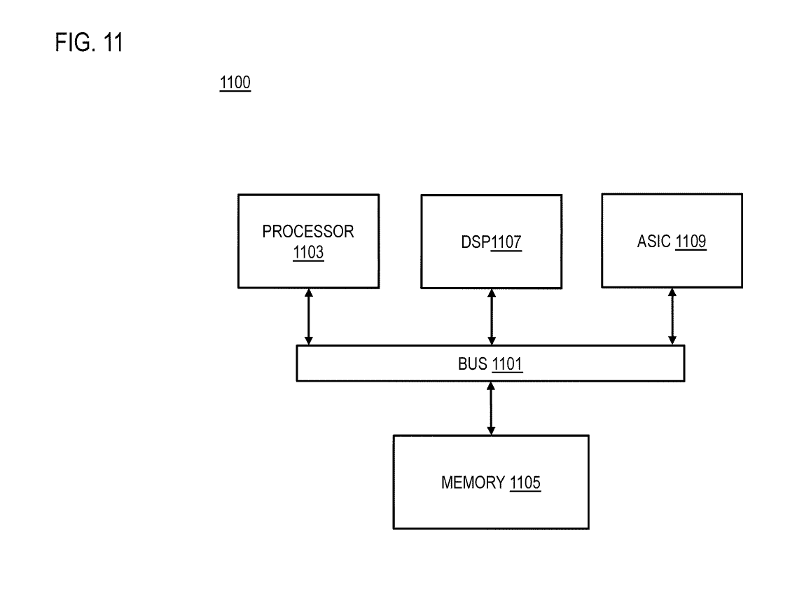

FIG. 4 is a flowchart of a process for providing augmented reality display spaces, according to one embodiment. In one embodiment, the content platform 111 performs the process 400 and is implemented in, for instance, a chip set including a processor and a memory as shown in FIG. 11. In one embodiment, the control logic 221 may determine one or more display surfaces within proximity of at least one device, wherein the one or more display surfaces are associated with one or more structures within an environment (step 401). For example, the control logic 221 and application 113 may communicate to determine device location and possible proximity of a device with known or potential display surfaces. Then, the control logic 221 may cause, at least in part, a retrieval of (a) one or more detection patterns for identifying the one or more display surfaces, the one or more structures, or a combination thereof in an augmented reality view; (b) content information associated with the one or more display surfaces; or (c) a combination thereof (step 403). For instance, the control logic 221 and application 113 may prompt UEs 101 to receive, from the pattern platform 109, detection patterns or content information for presentation.

Next, the control logic 221 may cause, at least in part, an identification of the one or more display surfaces, the one or more structures, or a combination thereof in the augmented reality view based, at least in part, on the one or more detection patterns (step 405); and cause, at least in part, a fixing of one or more three-dimensional (3D) models that represent the one or more display surfaces, the one or more structures, or a combination thereof to the one or more display surfaces, the one or more structures, or a combination thereof identified in the augmented reality view (step 407). For example, various display surfaces and structures may be associated with different content. In one embodiment, the control logic 221 may determine that certain advertisement providers are associated with certain display surfaces or structures. Then, the control logic 221 may interact with advertisement providers to determine what content to display and how to display it. For example, fixing the 3D models on display surfaces includes maintaining content positioning within the display surfaces. This fixing may further include dividing display surfaces into different regions so that various content items may be displayed at simultaneously.

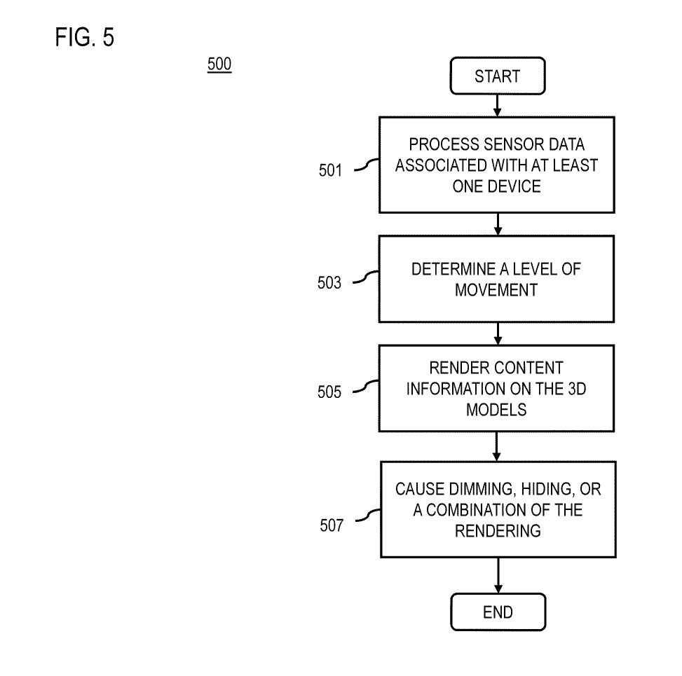

FIG. 5 is a flowchart of a process for rendering content information on at least a portion of the display spaces, according to one embodiment. In one embodiment, the content platform performs the process 500 and is implemented in, for instance, a chip set including a processor and a memory as shown in FIG. 11. In one embodiment, the control logic 221 may process and/or facilitate a processing of a sensor data associated with the at least one device to stabilize the fixing of the one or more 3D models in relation to the one or more display surfaces, the one or more structures, or a combination thereof identified in the augmented reality view (step 501).

Then, the control logic 221 may process and/or facilitate a processing of the sensor data to determine a level of movement of the at least one device (step 503) and cause, at least in part, a rendering of the content information on at least one portion of the one or more 3D models representing the one or more display surfaces, the one or more structures, or a combination thereof based, at least in part, on the fixing (step 505). As previously discussed, the rendering may include rendering content in various ways on portions of a display surface. In one embodiment, the control logic 221 may further render content while taking into account device movement rendering different content depending on device orientation. For example, the control logic 221 may render one set of content when a device is close to perpendicular to the ground and render another set of content while the device is almost parallel to the ground. Lastly, the control logic 221 may cause, at least in part, a dimming, a hiding, or a combination thereof of the rendering of the content information based, at least in part, on the level of movement (step 507). For example, where the control logic 221 detects too much movement to fix the model or stabilize content, the control logic 221 may diminish the rendering of content information.

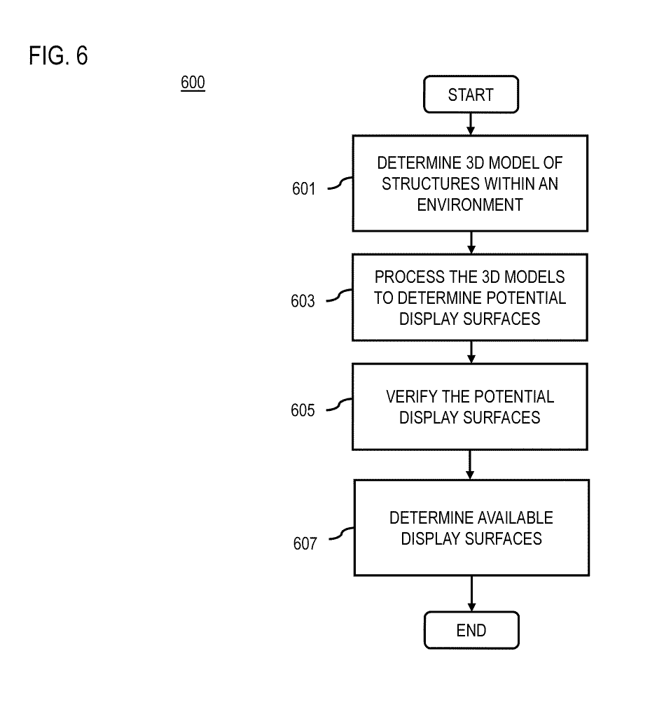

FIG. 6 is a flowchart of a process for determining available display spaces, according to one embodiment. In one embodiment, the pattern platform 109 performs the process 600 and is implemented in, for instance, a chip set including a processor and a memory as shown in FIG. 11. In one embodiment, the control logic 201 may determine one or more three-dimensional (3D) models of one or more structures within an environment (step 601). Then, the control logic 201 may process and/or facilitate a processing of the one or more 3D models to determine one or more potential display surfaces on the one or more 3D models (step 603). For example, the control logic 201 may determine potential display surfaces by determining bound shapes or bound, 2D geometric shapes.

From there, the control logic 201 may cause, at least in part, a verification of the one or more potential display surfaces against one or more reference 3D models to determine one or more available display surfaces (steps 605 and 607). As previously discussed, the reference models may be provided by content providers 107. In one embodiment, the control logic 201 may further determine where reference models are rarely used for verification and prompt discarding of the reference models so that the database of reference models stays relevant. In one embodiment, the control logic 201 may perform the verification wherein the verification of the one or more potential display surfaces to determine the one or more available display surfaces is based, at least in part, on one or more matching criteria, an user input for specifying a manual confirmation, or a combination thereof

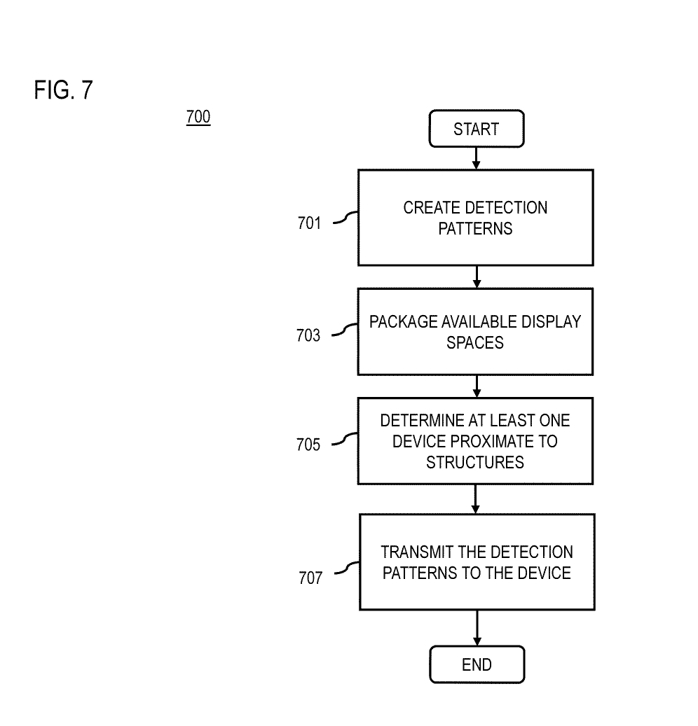

FIG. 7 is a flowchart of a process for transmitting appropriate detection patterns to a device, according to one embodiment. In one embodiment, detection pattern module 209 performs the process 700 and is implemented in, for instance, a chip set including a processor and a memory as shown in FIG. 11. In one embodiment, the control logic 301 may cause, at least in part, a creation of one or more detection patterns for identifying the one or more available display surfaces, the one or more structures, or a combination thereof in an augmented reality view (step 701). Then, the control logic 301 may cause, at least in part, a packaging of the one or more available display spaces, content information or presentation on the one or more available display spaces, the one or more detection patterns, or a combination thereof for transmission to at least on device that is proximate to the one or more structures (step 703). In one embodiment, the control logic 301 may communicate with various service, advertisement, and content providers to determine various groupings for packaging the display spaces, content information, and/or detection patterns. In a further embodiment, the control logic 301 may offer various tiers of packaging where different device or network capabilities determine which package is employed.

The control logic 301 may also cause, at least in part, an initiation of a transmission of the one or more detection patterns to a device based, at least in part, a proximity of the device to the one or more structures (steps 705 and 707). In one embodiment, the control logic 301 may further determine feedback information from one or more devices using the one or more detection patterns for identifying the one or more available display surfaces, the one or more structures, or a combination thereof and cause, at least in part, an updating of the one or more detection patterns based, at least in part, on the feedback information.

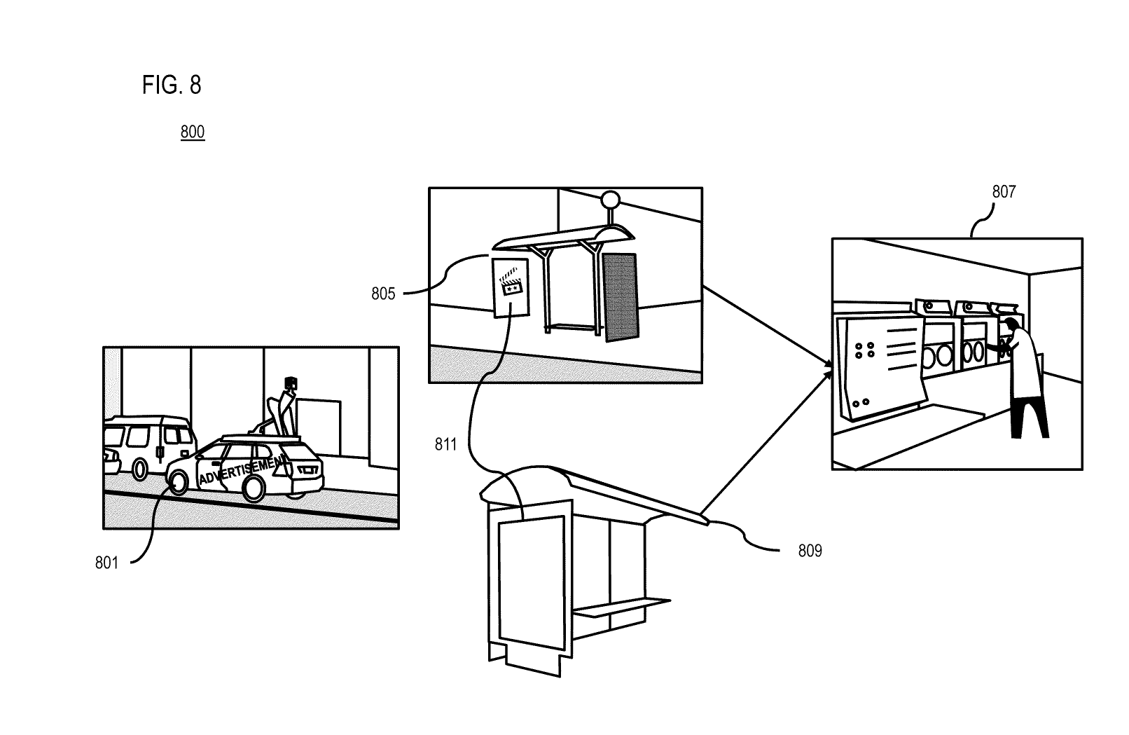

FIG. 8 is a diagram of a system 800 for processing 3D models and verifying potential display surfaces to determine available display surfaces. In one embodiment, 3D models are gathered via service providers 801. The 3D models may include 3D models of entire environments, including structures 805 presented within an augmented reality view of an environment. In some embodiments, the environments may include indoor environments and outdoor environments. Structures may include both stationary and mobile structures, for example, buildings and vehicles, respectively. In one embodiment, the system 800 may determine structures 805 within the 3D environment models provided by service providers 801 and cause verification 807. In one embodiment, verification 807 involves determining one or more reference 3D models 809 of the structures 805. In one embodiment, verification 807 may take into account various orientations or reference points to compare structures 805 within an augmented reality view and reference models 809 of various structures. For example, the orientation of one of the reference models 809 is different from that of structures 805. However, the system 800 may still verify the structures 805 as corresponding to one of the reference models 809. In one embodiment, one of the reference models 809 may further help determine available display surfaces in that verification 807 may include determining verifying display spaces 811 in structures 805 based on display surfaces in one of the reference models 809.

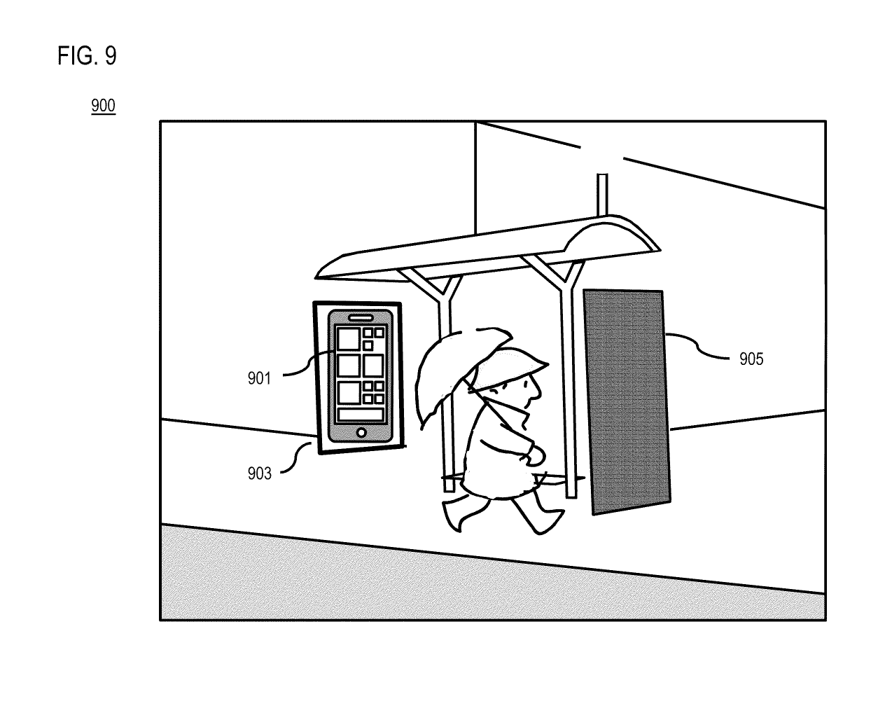

FIG. 9 is a diagram of a rendering 900 of an augmented reality view utilized in the processes of FIG. 5, according to one embodiment. In one embodiment, rendering 900 may include content information 901 on a display surface 903 of a 3D model 905 of a bus stop structure. In one embodiment, the 3D model 905 may be fixed on the actual bus stop structure identified in the augmented reality rendering 900. Then, the content information 901 may be stabilized relative to device sensor information. For example, content information 901 may stay within display surface 903 (and therefore fixed 3D model 905) regardless of the angle or orientation from which a user approaches the bus stop. In one embodiment, rendering 900 may include a modification to content information 901 due to a change in orientation from a device. Alternately, where motion exceeds a certain threshold where the 3D model 905 cannot be fixed, the rendering 900 may dim or hide content information 901.

The processes described herein for providing augmented reality display spaces may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

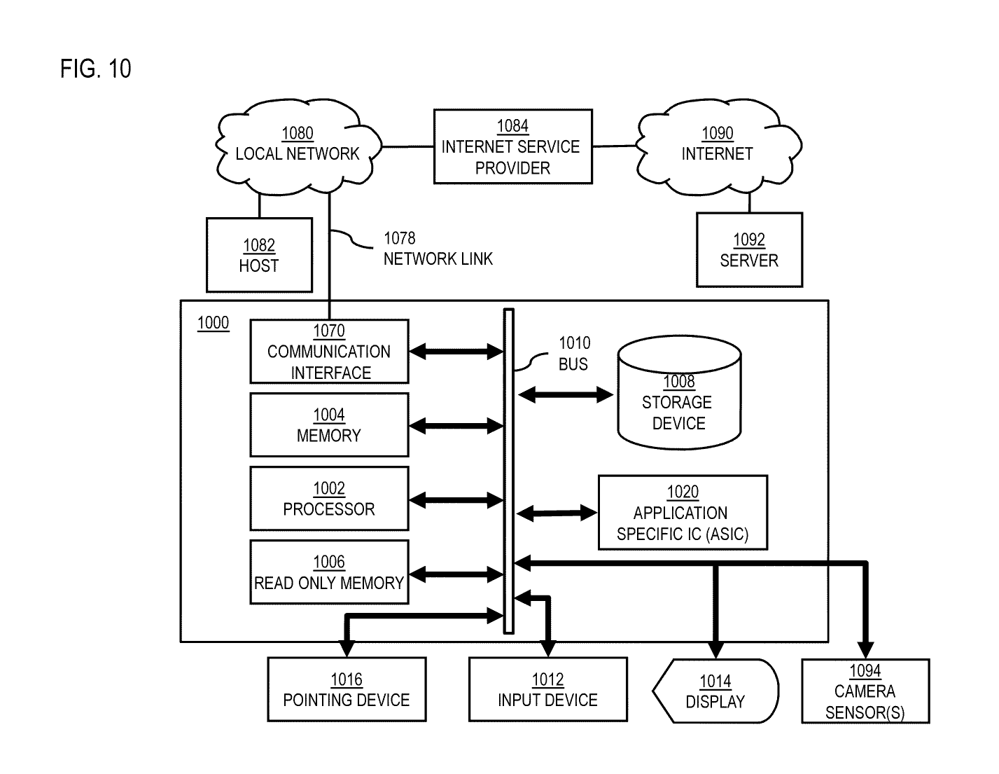

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to provide augmented reality display spaces as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of providing augmented reality display spaces.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to provide augmented reality display spaces. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random access memory (RAM) or any other dynamic storage device, stores information including processor instructions for providing augmented reality display spaces. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing augmented reality display spaces, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for providing augmented reality display spaces to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to provide augmented reality display spaces as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of providing augmented reality display spaces.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to display content using high accuracy wireframes. The memory 1105 also stores the data associated with or generated by the execution of the inventive steps.

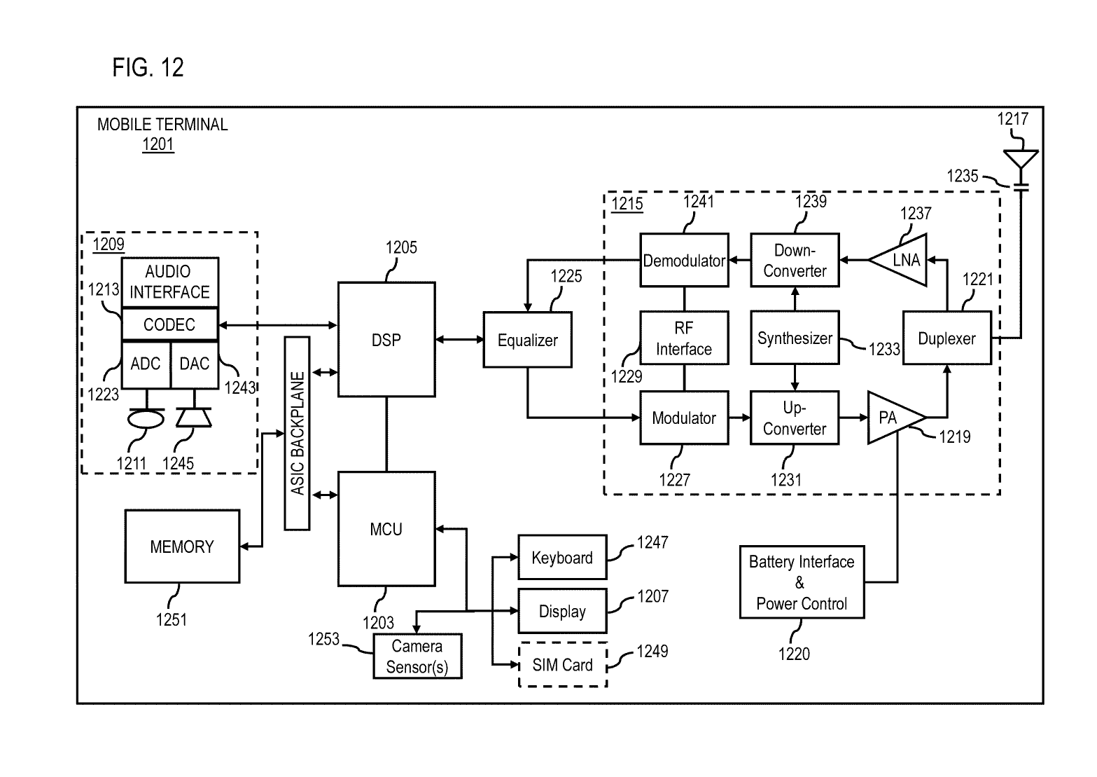

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of providing augmented reality display spaces. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of providing augmented reality display spaces. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to provide augmented reality display spaces. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
at least one determination of one or more display surfaces within proximity of at least one device, wherein the one or more display surfaces are associated with one or more structures within an environment; and
a retrieval of (a) one or more detection patterns for identifying the one or more display surfaces, the one or more structures, or a combination thereof in an augmented reality view; (b) content information associated with the one or more display surfaces; or (c) a combination thereof.

2. A method of claim 1, wherein the (1) data and/or (2) information and/or (3) at least one signal are further based, at least in part, on the following:
an identification of the one or more display surfaces, the one or more structures, or a combination thereof in the augmented reality view based, at least in part, on the one or more detection patterns; and
a fixing of one or more three-dimensional (3D) models that represent the one or more display surfaces, the one or more structures, or a combination thereof to the one or more display surfaces, the one or more structures, or a combination thereof identified in the augmented reality view.

3. A method of claim 2, wherein the (1) data and/or (2) information and/or (3) at least one signal are further based, at least in part, on the following:
a rendering of the content information on at least one portion of the one or more 3D models representing the one or more display surfaces, the one or more structures or a combination thereof based, at least in part, on the fixing.

4. A method of claim 2, wherein the (1) data and/or (2) information and/or (3) at least one signal are further based, at least in part, on the following:
a processing of sensor data associated with the at least one device to stabilize the fixing of the one or more 3D models in relation to the one or more display surfaces, the one or more structures, or a combination thereof identified in the augmented reality view.

5. A method of claim 4, wherein the (1) data and/or (2) information and/or (3) at least one signal are further based, at least in part, on the following:
a processing of the sensor data to determine a level of movement of the at least one device; and
a dimming, a hiding, or a combination thereof of the rendering of the content information based, at least in part, on the level of movement.

6. A method comprising facilitating a processing of and/or processing (1) data and/or (2) information and/or (3) at least one signal, the (1) data and/or (2) information and/or (3) at least one signal based, at least in part, on the following:
at least one determination of one or more three-dimensional (3D) models of one or more structures within an environment;
a processing of the one or more 3D models to determine one or more potential display surfaces on the one or more 3D models; and
a verification of the one or more potential display surfaces against one or more reference 3D models to determine one or more available display surfaces.

7. A method of claim 6, wherein the (1) data and/or (2) information and/or (3) at least one signal are further based, at least in part, on the following:
a creation of one or more detection patterns for identifying the one or more available display surfaces, the one or more structures, or a combination thereof in an augmented reality view.

8. A method of claim 7, wherein the (1) data and/or (2) information and/or (3) at least one signal are further based, at least in part, on the following:
a packaging of the one or more available display surfaces, content information for presentation on the one or more available display surfaces, the one or more detection patterns, or a combination thereof for transmission to at least one device that is proximate to the one or more structures.

9. A method of claim 7, wherein the (1) data and/or (2) information and/or (3) at least one signal are further based, at least in part, on the following:
an initiation of a transmission of the one or more detection patterns to a device based, at least in part, a proximity of the device to the one or more structures.

10. A method of claim 7, wherein the (1) data and/or (2) information and/or (3) at least one signal are further based, at least in part, on the following:
at least one determination of feedback information from one or more devices using the one or more detection patterns for identifying the one or more available display surfaces, the one or more structures, or a combination thereof; and
causing, at least in part, an updating of the one or more detection patterns based, at least in part, on the feedback information.

11. A method of claim 6, wherein the verification of the one or more potential display surfaces to determine the one or more available display surfaces is based, at least in part, on one or more matching criteria, an user input for specifying a manual confirmation, or a combination thereof.

12. An apparatus comprising:
at least one processor; and
at least one memory including computer program code for one or more programs,
the at least one memory and the computer program code configured to, with the at least one processor, cause the apparatus to perform at least the following,
determine one or more display surfaces within proximity of at least one device, wherein the one or more display surfaces are associated with one or more structures within an environment; and
cause, at least in part, a retrieval of (a) one or more detection patterns for identifying the one or more display surfaces, the one or more structures, or a combination thereof in an augmented reality view; (b) content information associated with the one or more display surfaces; or (c) a combination thereof.

13. An apparatus of claim 12, wherein the apparatus is further caused to:
cause, at least in part, an identification of the one or more display surfaces, the one or more structures, or a combination thereof in the augmented reality view based, at least in part, on the one or more detection patterns; and
cause, at least in part, a fixing of one or more three-dimensional (3D) models that represent the one or more display surfaces, the one or more structures, or a combination thereof to the one or more display surfaces, the one or more structures, or a combination thereof identified in the augmented reality view.

14. An apparatus of claim 13, wherein the apparatus is further caused to:
cause, at least in part, a rendering of the content information on at least one portion of the one or more 3D models representing the one or more display surfaces, the one or more structures or a combination thereof based, at least in part, on the fixing.

15. An apparatus of claim 13, wherein the apparatus is further caused to:
process and/or facilitate a processing of sensor data associated with the at least one device to stabilize the fixing of the one or more 3D models in relation to the one or more display surfaces, the one or more structures, or a combination thereof identified in the augmented reality view.

16. An apparatus of claim 15, wherein the apparatus is further caused to:
process and/or facilitate a processing of the sensor data to determine a level of movement of the at least one device; and
cause, at least in part, a dimming, a hiding, or a combination thereof of the rendering of the content information based, at least in part, on the level of movement.

17. An apparatus comprising:
at least one processor; and
at least one memory including computer program code for one or more programs,
the at least one memory and the computer program code configured to, with the at least one processor, cause the apparatus to perform at least the following,
determine one or more three-dimensional (3D) models of one or more structures within an environment;
process and/or facilitate a processing of the one or more 3D models to determine one or more potential display surfaces on the one or more 3D models; and
cause, at least in part, a verification of the one or more potential display surfaces against one or more reference 3D models to determine one or more available display surfaces.

18. An apparatus of claim 17, wherein the apparatus is further caused to:
cause, at least in part, a creation of one or more detection patterns for identifying the one or more available display surfaces, the one or more structures, or a combination thereof in an augmented reality view.

19. An apparatus of claim 18, wherein the apparatus is further caused to:
cause, at least in part, a packaging of the one or more available display surfaces, content information for presentation on the one or more available display surfaces, the one or more detection patterns, or a combination thereof for transmission to at least one device that is proximate to the one or more structures.

20. An apparatus of claim 18, wherein the apparatus is further caused to:
cause, at least in part, an initiation of a transmission of the one or more detection patterns to a device based, at least in part, a proximity of the device to the one or more structures.

21.-52. (canceled)
